(19) United States
(12) Patent Application Publication
(10) Pub. No.: US 2026/0182546 A1
(43) Pub. Date: Jul. 2, 2026

(54) CONTROLLER FOR BIRDHOUSE

(71) Applicant: NETVUE TECHNOLOGIES CO., LTD., SHENZHEN (CN)

(72) Inventors: Youle Hu, SHENZHEN (CN); Chuan Chen, SHENZHEN (CN); Rui Zhang, SHENZHEN (CN)

(21) Appl. No.: 19/378,462

(22) Filed: Nov. 4, 2025

(30) Foreign Application Priority Data
Dec. 26, 2024 (CN) 202423297539.6

(51) Int. Cl. A01K 31/14; G08B 21/18; H04W 4/38

(52) U.S. Cl. CPC A01K 31/14; G08B 21/18; H04W 4/38

(57) ABSTRACT

The present disclosure, relating to the technical field of birdhouses, provides a controller for a birdhouse. The controller includes a control unit and an extension member. The control unit is disposed outside the birdhouse. The extension member is configured to connect the control unit to a device disposed in the birdhouse, and the control unit is capable of controlling the device disposed in the birdhouse from outside a predetermined range of the birdhouse.

### CROSS-REFERENCE TO RELATED APPLICATIONS

This application is based upon and claims priority to Chinese Patent Application No. 202423297539.6, filed before China National Intellectual Property Administration on Dec. 26, 2024 and entitled “CONTROLLER FOR BIRDHOUSE”, the contents of which are incorporated herein by reference in their entire ties.

### TECHNICAL FIELD

The present disclosure relates to the technical field of birdhouses, and in particular, relates to a controller for a birdhouse.

### BACKGROUND

Artificial birdhouses are generally used to allow birds to nest therein. The entire process of the birds entering the birdhouse, nesting, feeding their young, and fledging, is recorded by video recording devices, such as cameras, for observation by users.

In addition to the video recording devices, a birdhouse is also commonly equipped with other devices such as temperature monitoring devices, lighting adjustment devices, audio devices, humidity sensing devices, and air quality sensing devices. This facilitates multi-faceted detection and monitoring of the internal environment of the birdhouse and provides a suitable living environment for the birds.

### SUMMARY

A primary objective of embodiments of the present disclosure is to provide a controller for a birdhouse that enables control of devices disposed within the birdhouse from a location outside a specific range of the birdhouse. This allows for simple and convenient operation, eliminates the need to open the birdhouse, and avoids disturbance to birds therein.

Accordingly, some embodiments of the present disclosure provide a controller for a birdhouse. The controller includes a control unit and an extension member. The control unit is disposed outside the birdhouse. The extension member is configured to connect the control unit to a device disposed in the birdhouse, and the control unit is capable of controlling the device disposed in the birdhouse from outside a predetermined range of the birdhouse.

### BRIEF DESCRIPTION OF THE DRAWINGS

FIG. 1 is a schematic structural diagram of a controller for a birdhouse according to some embodiments of the present disclosure;

FIG. 2 is a schematic structural diagram of a birdhouse and a controller for the birdhouse according to some embodiments of the present disclosure;

FIG. 3 is a schematic structural diagram of a birdhouse and a controller for the birdhouse with a side plate being concealed according to some embodiments of the present disclosure.

### REFERENCE NUMERALS AND DENOTATIONS THEREOF

100—controller;
1—control unit; 11—control button; 12—charging port; 13—second protection member; 14—status monitoring member; 14a—status indicator; 14b—audible alarm;
2—extension member; 21—first extension cord; 211—first connection terminal; 212—second connection terminal; 22—second extension cord; 221—third connection terminal; 222—fourth connection terminal; 23—third extension cord; 231—fifth connection terminal; 232—sixth connection terminal; 233—first protection member; 24—connector;
200—birdhouse;
300—device to be controlled.

### DETAILED DESCRIPTION

For better understanding of the present disclosure, the present disclosure is described in detail with reference to attached drawings and specific embodiments. It should be noted that, when an element is defined as “being secured or fixed to” another element, the element may be directly positioned on the element or one or more centered elements may be present therebetween. When an element is defined as “being connected or coupled to” another element, the element may be directly connected or coupled to the element or one or more centered elements may be present therebetween. In the description of the present disclosure, it should be understood that the terms “upper,” “lower,” “inner,” “outer,” “vertical,” “horizontal,” and the like indicate orientations and position relationships which are based on the illustrations in the accompanying drawings, and these terms are merely for ease and brevity of the description, instead of indicating or implying that the devices or elements shall have a particular orientation and shall be structured and operated based on the particular orientation. Accordingly, these terms shall not be construed as limiting the present disclosure. In addition, the terms “first,” “second,” and the like are merely for the illustration purpose, and shall not be construed as indicating or implying a relative importance.

Unless the context clearly requires otherwise, throughout the specification and the claims, technical and scientific terms used herein denote the meaning as commonly understood by a person skilled in the art. Additionally, the terms used in the specification of the present disclosure are merely for describing the objects of the specific embodiments, and are not intended to limit the present disclosure. As used herein, the term “and/or” in reference to a list of one or more items covers all of the following interpretations of the term: any of the items in the list, all of the items in the list and any combination of the items in the list.

In addition, technical features involved in various embodiments of the present disclosure described hereinafter may be combined as long as these technical features are not in conflict.

Artificial birdhouses are generally used to allow birds to nest therein. The entire process of the birds entering the birdhouse, nesting, feeding their young, and fledging, is recorded by video recording devices, such as cameras, for observation by users.

Furthermore, the birdhouse is also commonly equipped with other devices such as temperature monitoring devices, lighting adjustment devices, audio devices, video recording devices, humidity sensing devices, and air quality sensing devices, in order to facilitate the detection and monitoring of the environment within the birdhouse. However, these devices are generally disposed inside the birdhouse or on an outer wall of the birdhouse. When these devices malfunction, require maintenance due to an abnormality, need charging due to low battery, or need to be powered on or off, a user needs to approach the birdhouse and open the birdhouse to operate these devices. This may inevitably disturb the birds, which is extremely detrimental to health of the birds.

To solve the aforementioned problems, the present disclosure provides a controller for a birdhouse, which enables control of devices disposed in the birdhouse via a controller located outside the birdhouse. The controller also allows for real-time monitoring of the operational status of the devices, which provides for simple operation while avoiding disturbance to the birds.

Hereinafter, the specific structure and function of the controller according to the present disclosure is described in detail.

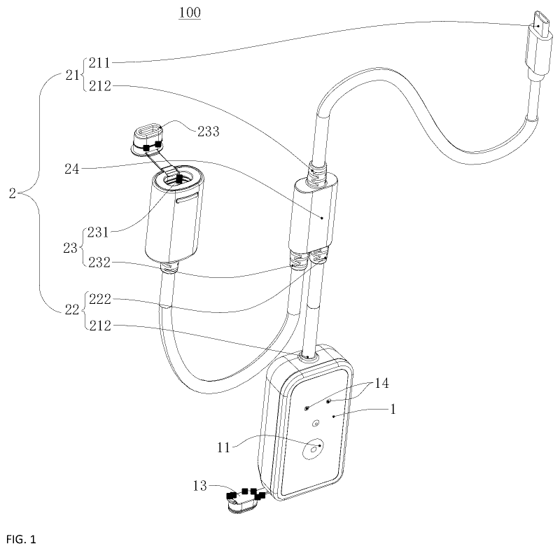

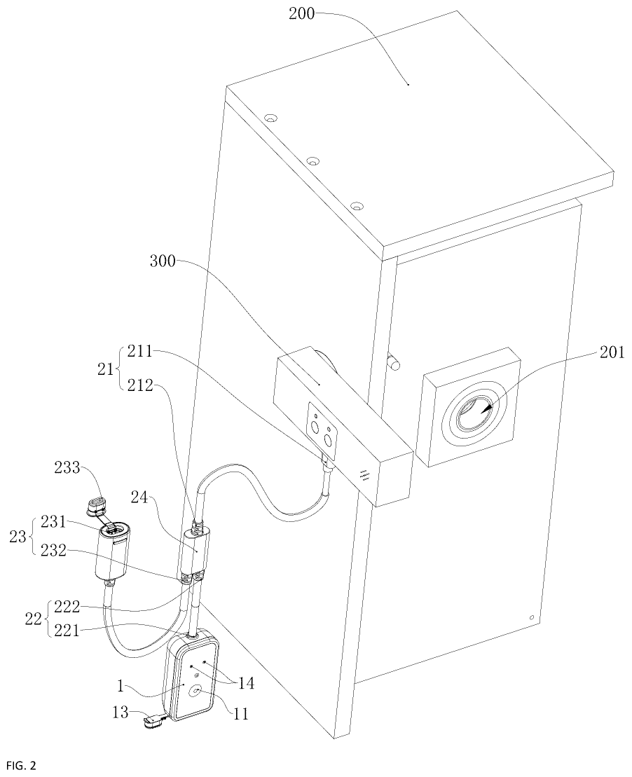

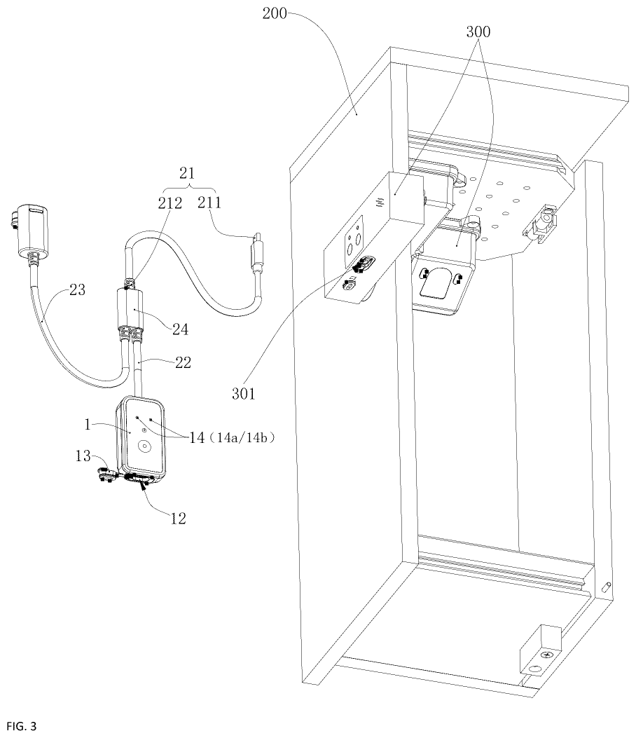

Referring to FIG. 1, FIG. 2, and FIG. 3, a controller 100 for a birdhouse includes a control unit 1 and an extension member 2. The extension member 2 connects the control unit 1 to a device disposed in the birdhouse. The device disposed in the birdhouse includes, but is not limited to, at least one of: a video recording device, a temperature monitoring device, a temperature adjustment device, a lighting adjustment device, an audio device, a temperature sensing device, a humidity sensing device, or an air quality sensing device. For convenience of description, hereinafter, the device disposed in the birdhouse is collectively referred to as a device to be controlled 300. The control unit 1 is disposed outside the birdhouse 200. The control unit 1 is used by a user to control the device to be controlled 300 when needed. The control unit 1 is configured to perform controls such as troubleshooting, restarting, charging, and powering on/off the device to be controlled 300, so as to ensure the normal response and operation of the device to be controlled 300, and thereby acquire image information and environmental information from within the birdhouse 200. The control unit 1 may be disposed outside a predetermined range of the birdhouse 200. In this embodiment, by controlling the device to be controlled 300 with the control unit 1, and by disposing the control unit 1 outside the birdhouse 200, the operation of the device to be controlled 300 may be managed via the control unit 1 with no need to open the birdhouse 200. The operation is simple and convenient, and disturbance to the birds inside the birdhouse 200 is avoided. Furthermore, by connecting the control unit 1 and the device to be controlled 300 with the extension member 2, the control unit 1 may be disposed outside the predetermined range of the birdhouse 200. The user may operate the control unit 1 from outside the predetermined range of the birdhouse 200, instead of standing close to the birdhouse 200, thereby further avoiding disturbance to the birds inside the birdhouse 200.

In addition to controlling the device to be controlled 300, the control unit 1 may also acquire and display the operational status of the device to be controlled 300 and issue a timely alert when an abnormality occurs in the device to be controlled 300, to notify the user to an take action. For example, when an abnormal situation such as a network connection error, low battery, or shutdown due to battery depletion occurs with the video recording device, the user is timely notified, via light or sound alarms, to handle this issue.

It is to be noted that the device to be controlled 300 may be disposed inside the birdhouse 200 or on the outer wall of the birdhouse 200. For example, a video recording device may be disposed inside the birdhouse 200 or at a bird entrance 201 on the outer wall of the birdhouse 200. It is to be understood that some of the devices to be controlled 300 may be disposed inside the birdhouse 200, while other devices to be controlled 300 are disposed on the outer wall of the birdhouse 200, which is not limited in the present disclosure.

In some embodiments, the extension member 2 wiredly connects the control unit 1 to the device to be controlled 300. Via a wired connection, signal transmission between the control unit 1 and the device to be controlled 300 is stable and reliable, and has high efficiency.

In some embodiments, the control unit 1 and the device to be controlled 300 may also be wirelessly connected. That is, the extension member 2 may be a Wi-Fi module or a Bluetooth module, and the extension member 2 is electrically connected to the device to be controlled 300. The control unit 1 is provided with a corresponding Wi-Fi module or a Bluetooth module for the extension member 2, such that the control unit 1 is capable of controlling the operation of the device to be controlled 300 via the Wi-Fi module or the Bluetooth module. Since the birdhouse 200 is typically placed outdoors, using a wireless connection reduces the use of wires, thereby reducing the risk of signal transmission between the control unit 1 and the device to be controlled 300 being affected by wires being gnawed by animals such as rodents.

In some embodiments, the control unit 1 may be detachably connected to the birdhouse 200. The control unit 1 may be detachably attached to the birdhouse 200, such as by magnetic attraction or hanging. For example, the controller 100 may be hung on an outer wall of the birdhouse 200. When the controller 100 is not in use, the controller 100 may be conveniently stored, reducing the risk of the controller 100 being lost. When it is necessary to control the device to be controlled 300, the control unit 1 is detached from the birdhouse 200 and placed at a designated location outside the predetermined range of the birdhouse 200 to operate the device to be controlled 300 from a distance, thereby avoiding disturbance to the birds inside the birdhouse 200.

In some embodiments, the control unit 1 is detachably hung on the outer wall of the birdhouse 200 to facilitate the control of the device to be controlled 300.

It is to be understood that, in addition to being detachably connected, the control unit 1 may also be fixedly attached to the outer wall of the birdhouse 200. By securing the control unit 1 to the outer wall of the birdhouse 200, the connection between the control unit 1 and the device to be controlled 300 may be conveniently established while preventing loss, thereby allowing a user to control the operation of the device to be controlled 300 via the control unit 1.

In some embodiments, the extension member 2 includes a first extension cord 21. The first extension cord 21 includes a first connection terminal 211 and a second connection terminal 212, wherein the first connection terminal 211 and the second connection terminal 212 are disposed opposite to each other. The first connection terminal 211 is electrically connected to the device to be controlled 300, and the second connection terminal 212 is electrically connected to the control unit 1. In this embodiment, a wired connection between the control unit 1 and the device to be controlled 300 is achieved via the first extension cord 21, providing a simple structure and a stable connection. Additionally, the provision of the first extension cord 21 allows the control unit 1 to be operated from a predetermined distance outside the birdhouse 200 to control the device to be controlled 300.

In some embodiments, the extension member 2 further includes a second extension cord 22 and a connector 24. The second extension cord 22 includes a third connection terminal 221 and a fourth connection terminal 222 at opposite ends thereof. The third connection terminal 221 is electrically connected to the control unit 1, and the fourth connection terminal 222 is electrically connected to the connector 24. Herein, the second connection terminal 212 is electrically connected to the connector 24, such that the control unit 1 is connected to the device to be controlled 300 sequentially via the second extension cord 22, the connector 24, and the first extension cord 21, thereby controlling the operation of the device to be controlled 300. The second extension cord 22 may further increase a maximum distance between the control unit 1 and the birdhouse 200, such that the control unit 1 is allowed to be as far as possible from the birdhouse 200 when used to control the device to be controlled 300. In this way, disturbance to the birds is reduced.

In some embodiments, the extension member 2 further includes a third extension cord 23. The third extension cord 23 includes a fifth connection terminal 231 and a sixth connection terminal 232 disposed at opposite ends thereof. The fifth connection terminal 231 is electrically connected to a solar power supply assembly (not shown), and the sixth connection terminal 232 is electrically connected to the connector 24. Herein, the second connection terminal 212, the fourth connection terminal 222, and the sixth connection terminal 232 are electrically connected to each other via the connector 24, such that the solar power supply assembly is capable of supplying electrical energy to the device to be controlled 300 sequentially via the third extension cord 23, the connector 24, and the first extension cord 21, thereby charging the device to be controlled 300. Furthermore, the solar power supply assembly may also supply power to the control unit 1 sequentially via the third extension cord 23, the connector 24, and the second extension cord 22.

In some embodiments, the second connection terminal 212 and the fourth connection terminal 222 are both electrically connected to the connector 24. That is, the first extension cord 21 and the second extension cord 22 are electrically connected to each other via the connector 24. The sixth connection terminal 232 is electrically connected to the connector 24, and electrically connected to at least one of the second connection terminal 212 and the fourth connection terminal 222, such that the solar power supply assembly is electrically connected to the device to be controlled 300 to supply power thereto. Alternatively, the sixth connection terminal 232 is connected directly to any one of: the device to be controlled 300, the control unit 1, or the first connection terminal 211, such that the use of the connector 24 is avoided and cost saving is facilitated. That is, the sixth connection terminal 232 may be electrically connected to the control circuitry via the connector 24, or may be directly connected to the device to be controlled 300 and the control unit 1.

In some embodiments, the solar power supply assembly is disposed on a top wall of the birdhouse 200 to facilitate the solar power supply assembly in capturing solar energy. It is to be understood that the solar power supply assembly may also be separate from the birdhouse 200.

In some embodiments, the control unit 1 may also control the solar power supply assembly. By controlling the supply of power from the solar power supply assembly to the device to be controlled 300, the risk of damage to the battery of the device to be controlled 300, caused by the solar power supply assembly continuously charging the battery for a prolonged period, may be reduced.

In some embodiments, the first connection terminal 211 is a plug, and the device to be controlled 300 has an interface 301. The plug is detachably pluggable into the interface 301, thereby achieving a connection between the controller 100 and the device to be controlled 300. By achieving the connection between the controller 100 and the device to be controlled 300 via the plug and the interface 301, the controller 100 may be stored away when not needed, such that the risk that the controller 100 is damaged by being gnawed by animals such as rodents is avoided.

It is to be noted that each of the devices to be controlled 300 (e.g., the temperature monitoring device, the temperature adjustment device, the lighting adjustment device, the audio device, the video recording device, the temperature sensing device, the humidity sensing device, and the air quality sensing device) may have its own independent interface 301. The controller 100 may control the corresponding device via the interface 301. It is to be understood that each of the devices to be controlled 300 may also be integrated into an integrated interface 301, and the controller 100 is configured to control the operation of each device via the integrated interface 301.

In some implementations, the fifth connection terminal 231 is a socket, and the third extension cord 23 includes a first protection member 233. The first protection member 233 is configured to seal the fifth connection terminal 231, thereby protecting the fifth connection terminal 231 and reducing the risk of contaminants, such as rain or dust which enters and corrodes the fifth connection terminal 231.

In some embodiments, the first protection member 233 is made of rubber.

In some embodiments, the control unit 1 is provided with a control button 11. The control button 11 is configured to control the operation of the device to be controlled 300. The control unit 1 is further provided with a status monitoring member 14 configured to monitor an operational status of the device to be controlled 300. The status monitoring member 14 is configured to issue a timely alert when an abnormality occurs in the device to be controlled 300, to promote the user to take an action. The status monitoring member 14 may also provide feedback on a control result when the control unit 1 is controlling the device to be controlled 300.

Further, the status monitoring member 14 includes a status indicator light 14a configured to indicate the operational status of the device to be controlled 300 and to provide a light-based alert when the operational status is abnormal. In addition, the status monitoring member 14 further includes an audible alarm 14b configured to provide an audible alert when the operational status is abnormal.

It is to be noted that when external sunlight is insufficient, the solar power supply assembly may not be able to supply sufficient electrical energy for the device to be controlled 300. Consequently, it is difficult for the device to be controlled 300 to run for an extended period. To solve this problem, in the present disclosure, the controller 100 is provided with a charging port 12. The charging port 12 may be connected to an external power source (not illustrated), such that the external power source supplies power to the device to be controlled 300 via the controller 100, thereby sustaining the operation of the device to be controlled 300.

In some embodiments, the control unit 1 is provided with a second protection member 13. The second protection member 13 is configured to seal the charging port 12, thereby protecting the charging port 12 and reducing the risk of contaminants, such as rain or dust which enters and causes corrosion within the charging port 12.

In some embodiments, the second protection member 13 is made of a rubber material.

In the embodiments of the present disclosure, by controlling the device to be controlled 300 with the control unit 1, and by disposing the control unit 1 outside the birdhouse 200, the operation of the device to be controlled 300 may be managed via the control unit 1 with no need to open the birdhouse 200. The operation is simple and convenient, and disturbance to the birds inside the birdhouse 200 is avoided. Furthermore, by connecting the control unit 1 and the device to be controlled 300 with the extension member 2, the control unit 1 may be disposed outside the predetermined range of the birdhouse 200. When operating the control unit 1, disturbance to the birds inside the birdhouse 200 may be further avoided.

Described above are exemplary embodiments of the present disclosure, but are not intended to limit the scope of the present disclosure. Any equivalent structure or equivalent process variation made based on the specification and drawings of the present disclosure, which is directly or indirectly applied in other related technical fields, fall within the scope of the present disclosure.

1. A controller for a birdhouse, comprising:
a control unit and an extension member;
wherein the control unit is disposed outside the birdhouse, the extension member is configured to connect the control unit to a device disposed in the birdhouse, and the control unit is capable of controlling the device disposed in the birdhouse from outside a predetermined range of the birdhouse.

2. The controller for a birdhouse according to claim 1, wherein the extension member is configured to wirelessly connect the control unit to the device disposed in the birdhouse.

3. The controller for a birdhouse according to claim 1, wherein the extension member is a Wi-Fi module and the extension member is electrically connected to the device disposed in the birdhouse, and a Wi-Fi module corresponding to the extension member is disposed in the control unit, such that the extension member connects the control unit to the device disposed in the birdhouse.

4. The controller for a birdhouse according to claim 1, wherein the extension member is a Bluetooth module and the extension member is electrically connected to the device disposed in the birdhouse, and a Bluetooth module corresponding to the extension member is disposed in the control unit, such that the extension member connects the control unit to the device disposed in the birdhouse.

5. The controller for a birdhouse according to claim 1, wherein the extension member is configured to wiredly connect the control unit to the device disposed in the birdhouse.

6. The controller for a birdhouse according to claim 1, wherein the extension member comprises a first extension cord, the first extension cord comprising a first connection terminal and a second connection terminal, wherein the first connection terminal is connected to the device disposed in the birdhouse, and the second connection terminal is connected to the control unit.

7. The controller for a birdhouse according to claim 6, wherein the extension member further comprises a second extension cord and a connector;
wherein the second extension cord comprises a third connection terminal and a fourth connection terminal, wherein the third connection terminal is connected to the control unit;
wherein the second connection terminal and the fourth connection terminal are both connected to the connector and are electrically connected to each other through the connector.

8. The controller for a birdhouse according to claim 7, wherein the extension member further comprises a third extension cord, wherein the third extension cord comprises a fifth connection terminal and a sixth connection terminal;
wherein the sixth connection terminal is configured to be connected to the connector, such that the sixth connection terminal is connected to at least one of the second connection terminal and the fourth connection terminal via the connector;
or the sixth connection terminal is configured to be connected to any one of the device disposed in the birdhouse, the control unit, or the first connection terminal.

9. The controller for a birdhouse according to claim 6, wherein the first connection terminal is a plug, and the device disposed in the birdhouse has an independent interface or an integrated interface for connecting to the first connection terminal.

10. The controller for a birdhouse according to claim 8, wherein the fifth connection terminal is a socket, and the third extension cord further comprises a first protection member configured to seal the fifth connection terminal.

11. The controller for a birdhouse according to claim 10, wherein the first protection member is made of rubber.

12. The controller for a birdhouse according to claim 1, wherein the control unit is detachably connectable to the birdhouse.

13. The controller for a birdhouse according to claim 12, wherein the control unit is detachably connectable to the birdhouse by magnetic attraction or hanging.

14. The controller for a birdhouse according to claim 1, wherein a control button is disposed on the control unit, wherein the control button is configured to control operation of the device disposed in the birdhouse.

15. The controller for a birdhouse according to claim 1, wherein a charging port is disposed in the control unit, wherein the charging port is configured to be connected to an external power source to charge the device disposed in the birdhouse.

16. The controller for a birdhouse according to claim 15, wherein the controller further comprises a second protection member, which is configured to seal and plug the charging port.

17. The controller for a birdhouse according to claim 16, wherein the second protection member is made of rubber.

18. The controller for a birdhouse according to claim 1, wherein a status monitoring member is disposed in the control unit, wherein the status monitoring member is configured to monitor an operational status of the device disposed in the birdhouse.

19. The controller for a birdhouse according to claim 18, wherein the status monitoring member comprises a status indicator, wherein the status indicator is configured to indicate the operational status of the device disposed in the birdhouse.

20. The controller for a birdhouse according to claim 18, wherein the status monitoring member comprises an audible alarm, wherein the audible alarm is configured to provide an audible alert in a case where the operational status of the device disposed in the birdhouse is abnormal.
